(19) United States
(12) Patent Application Publication
(10) Pub. No.: US 2004/0041849 A1
(43) Pub. Date: Mar. 4, 2004

(54) Display screen saver with two way messaging capability and method therefor

(76) Inventors: Von Mock, Boynton Beach, FL (US); Eric T. Eaton, Lake Worth, FL (US); David J. Hayes, Lake Worth, FL (US)

Correspondence Address: Randi L. Dulaney, Motorola, Inc., Law Department, 8000 West Sunrise Boulevard, Fort Lauderdale, FL, 33322, US

(21) Appl. No.: 10/231,662

(22) Filed: Aug. 30, 2002

(51) Int. Cl. G09G 5/00

(52) U.S. Cl. 345/867; 340/7.21

(57) ABSTRACT

An electronic information processing device (110) includes a transceiver (215), a CPU (120), and a display (225). The transceiver (215) receives one or more messages from at least one communication device (60) and transmits one or more messages to the at least one communication device (60). The CPU (120) is coupled to the transceiver (215) for processing the received and transmitted messages. The display (225) is coupled to the CPU (120). The display (225) includes a first screen layout (229) including a screen saver graphic, and a second screen layout (237) including a two way messaging interface window (240) for displaying the received and transmitted messages. The CPU (120) activates the second screen layout (237) for two way messaging communication with at least one information processing device user.

### BACKGROUND OF THE INVENTION

1. Field of the Invention

This invention relates in general to electronic information processing device application software and systems and more particularly to a screen saving application program with two way messaging capability.

2. Description of the Related Art

Electronic information processing systems such as those used to enhance productivity in an office environment or facilitate conveniences in the home all share a common problem. Typically, a display device of choice for desktop, portable, or countertop electronic information processing systems is the conventional cathode ray tube. It is well known that when an unchanging pattern is displayed on a cathode ray tube for extended periods of time, a phenomena called “burn-in” will occur. This damages the screen phosphors, resulting in a degradation of contrast and brightness in those areas of the cathode ray tube (CRT) subjected to the continuous display of an unchanging pattern. Displays such as liquid crystal displays (either active or passive matrix) experience a similar degradation in performance when subjected to the continuous display of an unchanging pattern. Consequently, the idea of a “screen saver” was developed.

Display screen savers can be classified in two primary groups. The first group comprises those screen savers that completely blank the display area by removing all signals from the display, resulting in a blank display. A second group of screen savers operates by animating a continuously changing pattern on the screen or display during that period in which the electronic information processing device is idle, e.g., when an information processing device user walks away from their desk. Screen savers have also been used to implement rudimentary security, e.g., once the display screen saver begins or the CRT is blanked, interaction with the electronic information processing device is prevented until a password is successfully entered. After entry of the correct password, the display screen saver is disabled and the electronic information processing device returns to normal operation. Additionally, the display screen saver function can be invoked by either a user supplied command or a default or programmable system time-out.

Accordingly, display screen saver programs effectively operate to extend the usable life of displays utilized by electronic information processing devices and have secondarily evolved to become a source of entertainment, information and personalization for the information processing device user. However, current state of the art display screen saver programs typically limit their utility to the “screen saving” function.

Some display screen saver applications allow the information processing device user to enter a pre-programmed message that is animated on the screen during the screen saver operation. This feature, for example, can be used to display information regarding the information processing device user's whereabouts and contact information. However, a visitor is still relegated to using conventional means, such as a telephone or selective call receiver (e.g., messaging system), to contact the information processing device user. Because conventional display screen savers disable operation of the electronic information processing device until the correct password is entered, the visitor viewing the screen saving display and information cannot use the electronic information processing device running the screen saver for the entry of data, or initiation of electronic messaging. Thus, the visitor must pick up the phone, dial the information processing device user's extension number, or dial their messaging service, manually entering the information processing device user's messaging device address or identification number, and a corresponding message. Even once this has been done, there are no assurances that the individual trying to be reached can be reached, or will receive the message.

A one-way solution to this problem is described in U.S. Pat. No. 6,256,008, issued Jul. 3, 2001 to Sparks et al. and titled “Computer Screen Saver With Wireless Messaging Capability And Method Therefor” which is assigned to the assignee of the present invention, and which is incorporated by reference herein. U.S. Pat. No. 6,256,008 describes a wireless screen saver having a first screen layout persisting until a user input is detected. Upon detection of the user input, a second screen layout is invoked, presenting a virtual messaging device for accepting and displaying a message for transmission to a messaging device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a two way messaging system configured for operation in accordance with the present invention.

FIG. 2 illustrates an electronic information processing device configured for operation in accordance with the preferred embodiment of the present invention.

FIG. 3 illustrates one embodiment of a display for use within the electronic information processing device of FIG. 2.

FIG. 4 illustrates a second embodiment of a display for use within the electronic processing device of FIG. 2 in accordance with the present invention.

FIG. 5 is an exemplary flow diagram illustrating one embodiment of the operation of the electronic information processing device of FIG. 2 in accordance with the present invention.

FIG. 6 illustrates a plurality of user preferences that can be utilized by a screen saver messaging application within the electronic information processing device of FIG. 2 in accordance with the preferred embodiment of the present invention.

FIG. 7 is an exemplary flow diagram illustrating one embodiment of the operation of updating the user preferences of FIG. 6 in accordance with the present invention.

FIG. 8 illustrates a short-range protocol system operating within the two way messaging system of FIG. 1 in accordance with the preferred embodiment of the present invention.

FIG. 9 is an electronic block diagram of a communication device for use within the two way messaging system of FIG. 1, in accordance with a preferred embodiment of the present invention.

FIG. 10 illustrates a screen saver message memory for use within the communication device of FIG. 9 in accordance with a preferred embodiment of the present invention.

### DETAILED DESCRIPTION OF THE PREFERRED EMBODIMENT(S)

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

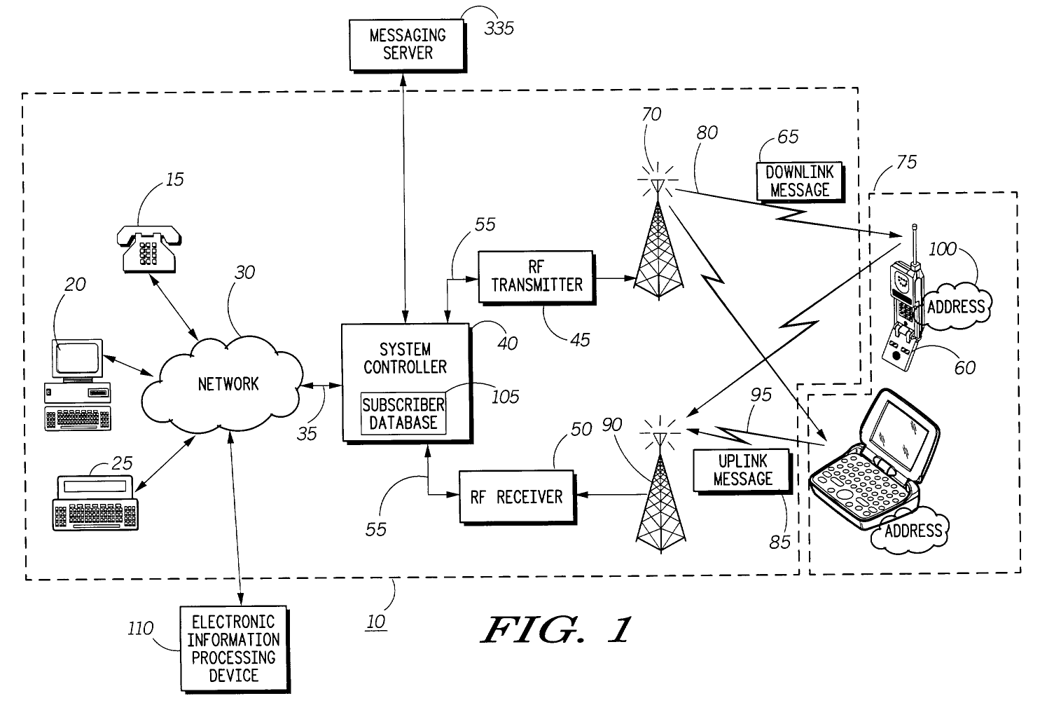

Referring to FIG. 1, an electronic block diagram of a two way messaging system 10 configured for operation in accordance with the present invention is shown. Although FIG. 1 illustrates specifically a two way wireless messaging system, it will be appreciated by those of ordinary skill in the art that the two way messaging system 10 can include any wireless and/or wireline system in accordance with the present invention. The two way messaging system 10 includes a message input device for initiating messages into the two way messaging system 10. It will be appreciated by those of ordinary skill in the art that the message input device can alternatively be external to the two way messaging system 10. The message input device can be, for example, a telephone 15, a computer 20, a desktop messaging unit 25, or an electronic information processing device 110, connected through a conventional network 30 through a plurality of terminal links 35 to a system controller 40. The terminal links 35, for example, can be a plurality of twisted wire pairs, a fiber optic cable, or a multiplexed trunk line.

The system controller 40 is coupled to and oversees the operation of at least one radio frequency (RF) transmitter 45 and at least one radio frequency (RF) receiver 50 through one or more communication links 55. The communication links 55 typically are twisted pair telephone wires, and additionally can include radio frequency (RF), microwave, or other communication links. The radio frequency transmitter 45 and the radio frequency receiver 50 typically are used with message store and forward stations that encode and decode inbound and outbound messages into formats that are compatible with landline message switched computers and personal radio addressing requirements, such as cellular messages, short messaging service, or paging protocols. The system controller 40 can also function to encode and decode wireless messages that are transmitted to or received by the radio frequency transmitter 45 or the radio frequency receiver 50. Telephony signals are typically transmitted to and received from the system controller 40 by telephone sets such as the telephone 15 or a communication device 60. The system controller 40 encodes and schedules outbound messages such as a downlink message 65. The system controller 40 then transmits the encoded outbound messages through the radio frequency transmitter 45 via a transmit antenna 70 to a plurality of communication devices 75 such as the communication device 60 on at least one outbound radio frequency (RF) channel 80. The downlink message 65 can be, for example, a data message or a voice call. Similarly, the system controller 40 receives and decodes inbound messages such as an uplink message 85 received by the radio frequency receiver 50 via a receive antenna 90 on at least one inbound radio frequency (RF) channel 95 from one of the plurality of communication devices 75. The uplink message 85 can be, for example, a data message, a reply to a data message, a voice call, or a reply to a voice call.

It will be appreciated by one of ordinary skill in the art that the two way messaging system 10, in accordance with the present invention, can function utilizing any wireless RF channel, for example, a two-way messaging channel, a mobile cellular telephone channel, or a mobile radio channel. Similarly, it will be appreciated by one of ordinary skill in the art that the two way messaging system 10 can function utilizing other types of wireless communication channels such as infrared channels and/or Bluetooth channels. Similarly, it will be appreciated by one of ordinary skill in the art that the two way messaging system 10 can function utilizing a wireline communication channel such as a local area network (LAN) or a wide area network (WAN) or a combination of both. The LAN, for example, can employ any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures to enable the communication among the devices and/or between the devices and the shared resources. The WAN, for example, can use a physical network media such as X.25, Frame Relay, ISDN, Modem dial-up or other media to connect devices or other local area networks. In the following description, the term “two way messaging system” refers to any of the two way messaging systems mentioned above or an equivalent.

Similarly, it will be appreciated by one of ordinary skill in the art that each of the plurality of communication devices 75, such as the communication device 60, in accordance with the present invention, can be a mobile cellular telephone, a mobile radio data terminal, a mobile cellular telephone having an attached data terminal, a personal computer having a communication means either built in or attached, or a two way messaging device, such as the “Pagewriter 2000X” manufactured by Motorola Inc. of Schaumburg, Ill. Similarly, each of the plurality of communication devices 75 can operate on a network that uses a physical network such as ARCNET, Ethernet, Token-ring, Local Talk or other network media to connect the computers, which represent wired network nodes into the network. In the following description, the term “communication device” refers to any of the devices mentioned above or an equivalent.

Each of the plurality of communication devices 75 assigned for use in the two way messaging system 10 have an address or identity assigned thereto which is a unique selective call address in the two way messaging system 10. For example, the communication device 60 assigned for use in the two way messaging system 10 has an address 100 assigned thereto which is a unique selective call address in the two way messaging system 10 for the communication device 60. The address 100 enables the transmission of the downlink message 65 from the system controller 40 only to the communication device 60 having the address 100, and identifies the messages and responses received at the system controller 40 from the communication device 60 with the address 100. In one embodiment, each of the plurality of communication devices 75 also has a pin number assigned thereto, the pin number being associated with a telephone number within the network 30. A list of the assigned addresses and correlated telephone numbers for each of the plurality of communication devices 75 is stored in the system controller 40 in the form of a subscriber database 105.

In a preferred embodiment of the present invention, the two way messaging system 10 further includes a messaging server 335. The messaging server 335 preferably manages the communication of a plurality of electronic messages among a plurality of devices including the plurality of communication devices 75, facilitating substantially real time communication among the plurality of devices within the two-way messaging system 10. It will be appreciated by one of ordinary skill in the art that one or more messaging servers can be utilized to provide the functions of the messaging server 335, and further that the one or more messaging servers can alternatively be external to the two way messaging system 10.

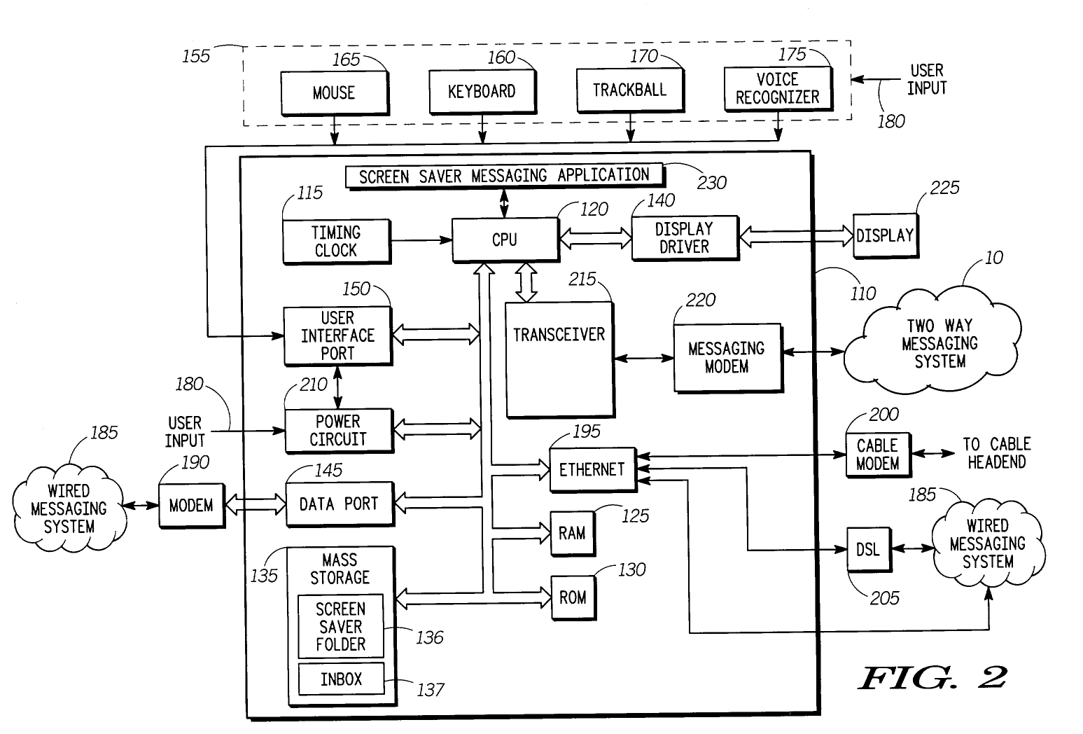

Referring to FIG. 2, the illustration shows the electronic information processing device 110, configured for operation in accordance with a preferred embodiment of the present invention. The electronic information processing device 110 can encompass any number of devices such as a dedicated pocket messaging assistant, a personal computer, an electronic pocket organizer, a laptop computer, a personal digital assistant, or the like. The electronic information processing device 110 can operate for example on a local area network (LAN) or a wide area network (WAN) or a combination of both. The electronic information processing device 110 can be one of a plurality of spatially co-located computers which are typically located within a room, building or campus of buildings and are sharing common resources and communicating with each other on a computer network in a manner well known to one of ordinary skill in the art. Typical resources shared are files on a file server, printers on a print server, and electronic message (email) services on an email server. The electronic information processing device 110 can operate on a network that uses a physical network such as ARCNET, Ethernet, Token-ring, Local Talk or other network media to connect the computers, which represent wired network nodes into the network. The electronic information processing device 110 can operate on a LAN that employs any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures to enable the communication among the devices and/or between the devices and the shared resources. Further the electronic information processing device 110 can operate on a WAN that uses a different physical network media such as X.25, Frame Relay, ISDN, Modem dial-up or other media to connect other computers or other local area networks. In the following description, the term “electronic information processing device” includes any of the devices operating as described above or an equivalent.

As illustrated, the electronic information processing device 110 minimally comprises a timing clock 115, a central processing unit 120, an electronic memory preferably in the form of a random access memory (RAM) 125 and/or a read only memory (ROM) 130, and a mass storage element (e.g., a disk drive or the like) 135. The mass storage element 135 preferably includes a screen saver folder 136 and an inbox 137. Completed message sessions and associated messages and information preferably are stored in the screen saver folder 136 and unread messages of active message sessions preferably are stored in the inbox 137.

The electronic information processing device 110 further preferably comprises a display driver 140, a general I/O interface or data port 145, and a user interface port 150 that accommodates a user interface 155 including any number of input means for general information entry. In the preferred embodiment, the user interface 155, e.g., a keyboard 160, a “mouse,” 165, a pen or puck activated tablet (not shown), a trackball 170, an audio activated command recognition processor 175, or the like, allows an information processing device user to enter and manipulate information using a user input 180. After information is entered, it can be communicated to a wired messaging system 185 via a conventional modem 190 or the like. Preferably, the electronic information processing device 110 also includes an Ethernet connection 195 for communicating to the wired messaging system 185 or for communicating through either a conventional cable modem 200 to a cable headend, or a (Digital Subscriber Line) DSL connection 205 to the wired messaging system 185. The electronic information processing device 110 can be changed from an active to an inactive state or from an inactive state to an active state through the user input 180 to a power circuit 210. The power circuit 210 can be operated manually via the user input 180 directly to the power circuit 210, the user input 180 to the user interface 155, or alternatively automatically via the programming of the CPU 120.

In one embodiment of the present invention, the electronic information processing device 110 further comprises a transceiver 215 coupled to the CPU 120 for receiving and transmitting messages from/to the two way messaging system 10 via a messaging modem 220. The transceiver 215 employs conventional demodulation techniques for receiving the communication signals transmitted by the two way wireless messaging system 120. The transceiver 215 further is responsive to commands from the CPU 120. When the transceiver 215 receives a command from the CPU 120, the transceiver 215 sends a signal via the messaging modem 220 to the two way messaging system 10. It will be appreciated by one of ordinary skill in the art that the electronic information processing device 110 can alternatively comprise a receiver circuit and a transmitter circuit (not shown) to perform the functions of the transceiver 215 in accordance with the present invention.

Preferably the CPU 120 automatically updates a display 225 when a new message has been sent or received by sending a command to the display driver 140. This allows the message to be updated while the information processing device user is reading it without disturbing the display 225. The CPU 120 further is programmed to perform functions relating to various received and/or sent messages. For example, the CPU 120 can be programmed to include various alert options. In one embodiment, the CPU 120 sends a command to an alert circuit (not shown) when a new message is received. In another embodiment, the CPU 120 sends a command to the alert circuit when an unread message is to be deleted from the memory. Alternatively, no alert may be sent when a new message is received and stored in the memory. It will be appreciated by one of ordinary skill in the art that other alerting schemes are within the scope of the present invention.

In a preferred embodiment of the present invention, the electronic information processing device 110 includes a screen saver messaging application 230 coupled to the CPU 120. The screen saver messaging application 230 can be hard coded or programmed into the electronic information processing device 110 during manufacturing, can be programmed over-the-air upon customer subscription, or can be a downloadable application. It will be appreciated that other programming methods can be utilized for programming the screen saver messaging application 230 into the electronic information processing device 110. It will be further appreciated by one of ordinary skill in the art that the screen saver messaging application 230 can be hardware circuitry within the electronic information processing device 110.

Preferably the screen saver messaging application 230 automatically updates the display 225 by sending an application command to the CPU 120 causing the CPU 120 to then send a command to the display driver 140. The screen saver messaging application 230 uses one or more user preferences either programmed into the screen saver messaging application 230 or alternatively stored in the electronic memory to manage a plurality of screen saving two way messaging functions by providing one or more commands to the CPU 120. It will be appreciated by one of ordinary skill in the art that the user preferences can be specialized and personalized including display options and screens for an individual information processing device user, or similarly can include one or more user preferences for an individual messaging session. Alternatively, the user preferences can be standard, pre-defined display options and screens for all information processing device users of the electronic information processing device 110.

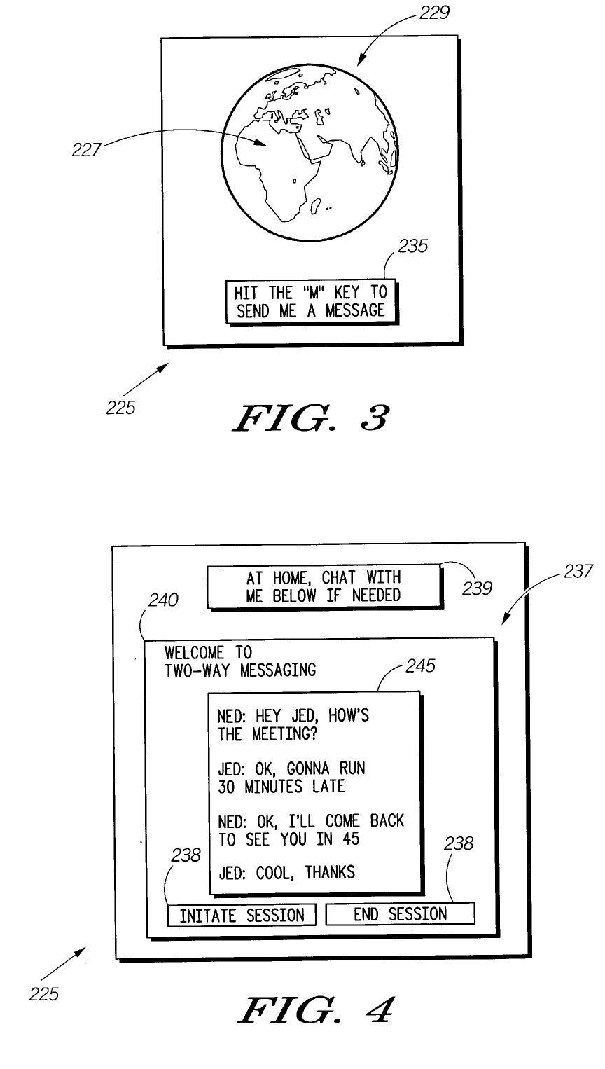

FIG. 3 illustrates one embodiment of a first screen layout 229 of the display 225 associated with a first mode of operation of the screen saver messaging application 230. As illustrated, the first screen layout 229 of the display 225 includes a screen saver graphic 227 which can include, in both fixed and animated states, text, alphanumeric characters, and/or graphic depictions, in any combination. For example the screen saver graphic 227 can be a slide show. In accordance with the present invention, the first screen layout 229 of the display 225 further includes a method of communication message 235 in the form of a plurality of scrolling text to inform visitors of one or more ways to communicate with one or more information processing device users of the electronic information processing device 110. The plurality of scrolling text, for example, can include the text regarding their availability, location, or the like. Examples of the plurality of scrolling text include: “Press any key to send me a message.” It will be appreciated that the method of communication message 235 could be delivered using any kind of media such as audio, video, graphic depictions and the like, in any combination. A visitor can communicate with one or more information processing device users of the electronic information processing device 110 by initiating the user input 180 to the user interface 155 of the electronic information processing device 110 thereby invoking a second mode of the screen saver messaging application 230.

FIG. 4 illustrates a second screen layout 237 of the display 225 associated with the second mode of operation of the screen saver messaging application 230 that includes real time and non-real time two way messaging capabilities. Preferably, the second screen layout 237 includes a two way messaging interface window 240 activated on the display 225 to facilitate the two way messaging communication. Preferably, the second screen layout 237 further includes a second window of scrolling text 239 informing visitors of additional information with regard to communicating with the information processing device user. The second window of scrolling text, for example, can include the text regarding their availability, location, or the like. Examples of the second window of scrolling text include: “Chat with me using the keyboard because I'll be out of office all week traveling” OR “At home today, but if you have any urgent matters pull up a chair and chat with me on my computer.”

In accordance with the present invention, the information processing device user via a user input to the user interface 155 can activate the second screen layout 237 including the two way messaging interface window 240. Alternatively, the second screen layout 237 including the two way messaging interface window 240 can be activated automatically based on the local presence or absence of the information processing device user. For example, local presence of the information processing device user can be communicated to the electronic information processing device 110 via one or more short range wireless channels such as Bluetooth to switch between two different screen saver applications, one with the two way messaging interface window 240 and functionality and another without. Alternatively, a message can be sent to the electronic information processing device 110 from a communication device 60 to switch between a standard screen saver application and the screen saver messaging application 230. The message, for example can be sent in response to detection of the user input 180. It will be appreciated by those of ordinary skill in the art that, in accordance with the present invention, the standard screen saver application and the screen saver messaging application 230 can be implemented as two different states of the same screen saver application, or alternatively, as two separate applications. It will further be appreciated by those of ordinary skill in the art that other methods to switch between a standard screen saver application and the screen saver messaging application 230 can be used in accordance with the present invention.

The two way messaging interface window 240 can include, for example, several context sensitive function buttons 238 (two of which are illustrated) that allow either visitor (e.g., one without password access to the electronic information processing device 110) or an authorized user (for example: the information processing device user) to execute functions such as to “send” a message, “clear” a previously entered message (if an error was made), “lock” the screen, “setup” preferences associated with the screen saver messaging application 230 (e.g., timeout, messaging service provider, destination(s) such as the information processing device user's communication device, or possibly one or more other designated devices), “about” which provides information such as the copyright and source of origin of the screen saver messaging application 230, and “exit” which aborts the entry process, returning to a pre-programmed screen saver display. The two way messaging interface window 240 can further include a status indicator of messaging activity such as “message sent” and/or can include a progress bar indicating “waiting for reply” with possible estimated time of completion. The two way messaging interface window 240 preferably includes an appearance scheme. The appearance scheme, for example, can be a graphical depiction of the communication device 60 being utilized by the information processing device user. Similarly, the appearance scheme can be a graphical depiction of the personal computer of the information processing device user. Preferably, the appearance scheme of the two way messaging interface window 240 is associated with the location and/or the device used by the information processing device user. For example, when the information processing device user is at home the appearance scheme can be a personal computer and when the information processing device user is traveling the appearance scheme can be a wireless communication device.

Each inputted message to a messaging session is relayed to the information processing device user's communication device 60. The information processing device user can respond with their own messages, which are likewise relayed to the electronic information processing device 110. These messages are typically text messages that are delivered in a real time manner. However, these messages can be in a variety of different media formats or combinations thereof such as audio, animation, video, images, etc. Additionally, each message can be an identification tag identifying it as a screen saver message. A session history of the messages received and transmitted by all participants involved in the messaging session is typically presented on the two way messaging interface window 240 in the form of a scrolling dialog.

A visitor can initiate a messaging session 245 with one or more information processing device user of the electronic information processing device 110 via the user interface 155. In one embodiment, the one or more information processing device users includes a plurality of individuals within a directory listing, for example within a corporation/business. (i.e. kiosks) The electronic information processing device 110 then transmits inputted messages to and receives messages from the communication device 60 of the one or more information processing device users, via the two way messaging system 10 such as discussed in reference to FIG. 1, thereby creating the messaging session 245 as illustrated. While the messaging session 245 is active, the messages for the messaging session 245 can be stored in the inbox 137 of the mass storage element 135. In accordance with the present invention, message receipt verification can be sent to the screen saver messaging application 230 using an underlying transport such as email. The messaging session 245 can terminate either in response to the user input 180 or automatically in response to a timeout of a timer. (i.e. inactivity timer). After the messaging session 245 is completed, the display 225 preferably reverts back to the first screen layout 229.

As stated earlier, it is well known that when an unchanging pattern is displayed on a cathode ray tube or a liquid crystal display for extended periods of time, a phenomena called “burn-in” will occur. This damages the screen phosphors or picture elements, resulting in a degradation of contrast and brightness in those areas of the cathode ray tube (CRT) subjected to the continuous display of an unchanging pattern. The first screen layout 229 is preferably animated about the display 225 in a pseudo-random pattern that minimizes burn-in of display elements associated with the display 225. Thus, the display 225 performance is preserved, thus extending the useful life of the display 225.

Once the first screen layout 229 is reactivated, the content of the messaging session 245 can be stored in the electronic memory for future reference by the information processing device user, and the two way messaging interface window 240 and its contents preferably are destroyed. For example, the session history of each messaging session can be stored by the screen saver messaging application 230 in the screen saver folder 136 within the mass storage element 135 for recording purposes. Sequence numbers can be used to identify messaging session flow and order. The present invention thereby allows any visitor to send and receive messaging content to/from one or more information processing device users without knowledge of the address and/or contact information of each of their communication devices.

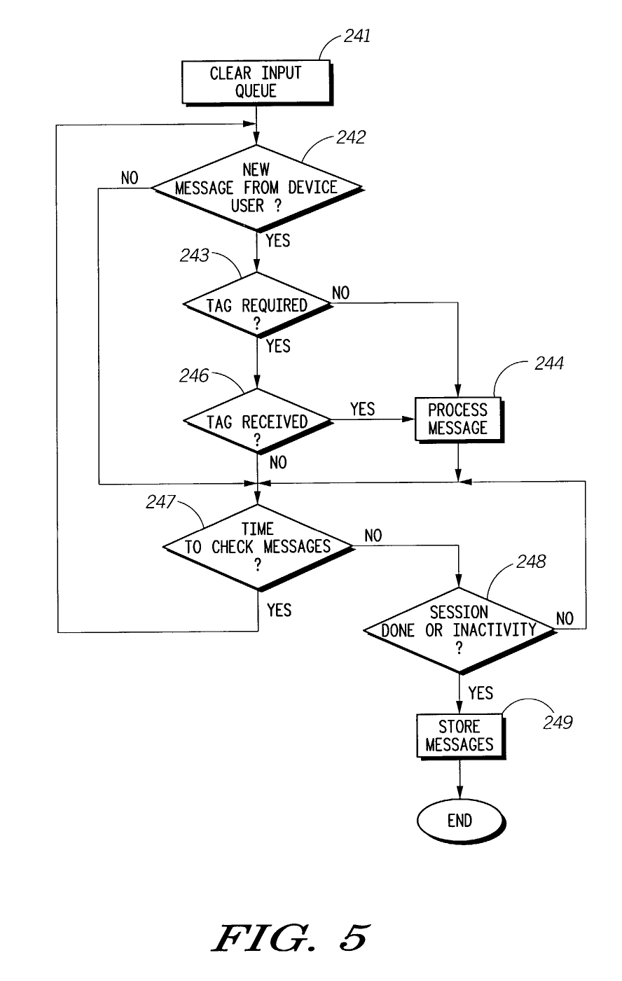

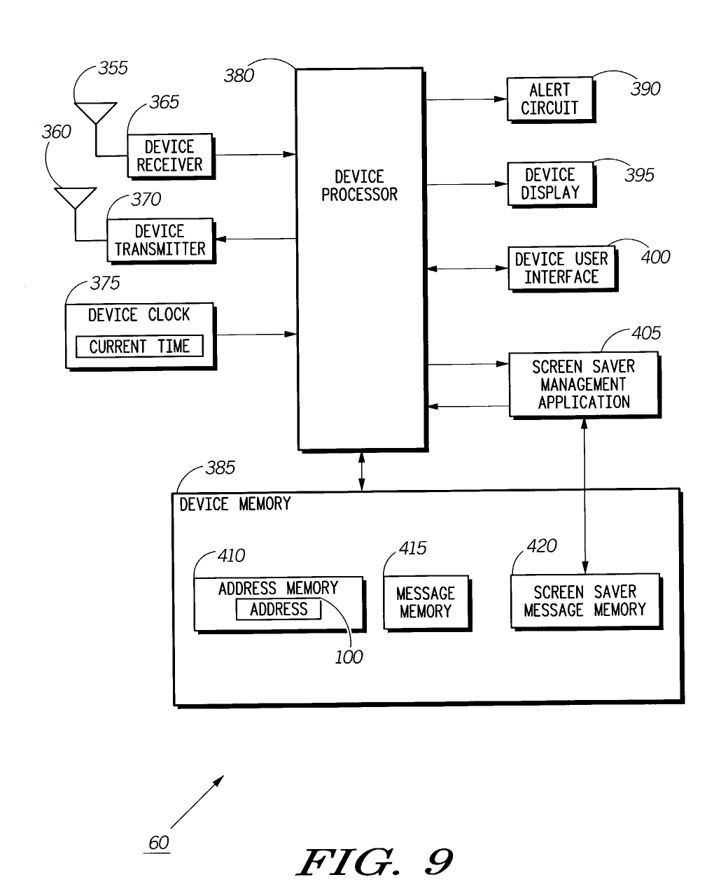

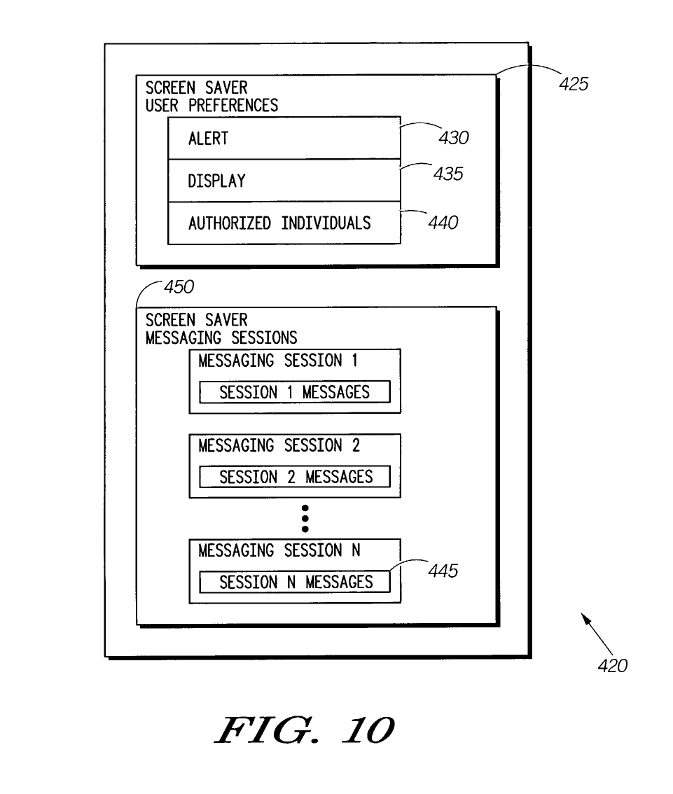

FIG. 5 is an exemplary flow chart of the operation of the electronic information processing device 110 of FIG. 2 in accordance with the present invention. Specifically, FIG. 5 illustrates the receiving and processing of messages by the screen saver messaging application 230 of the electronic information processing device 110. The process begins with Step 241 in which any existing messages from previous messaging session are removed from the input queue. This step clears any delayed responses to previous messaging sessions. For example, any messages received before the screen saver messaging application 230 entered the second mode are discarded or ignored. Next, in Step 242, the screen saver messaging application 230 determines whether one or more new messages have been received from the information processing device user. For example, the sender's email address is equivalent to the email address of the information processing device user's communication device. Further, the screen saver messaging application 230 can be programmed with the equivalent email domains for different service providers. The new message, for example, can be a message containing new text for the method of communication message 235 and/or for the second window of scrolling text 239. In Step 243, when a new message has been received from the information processing device user in Step 242, the screen saver messaging application 230 determines whether an identification tag accompanying the new message is required. The identification tag, for example can be a predefined text string contained within the message, an identification for the message session, an identification for the message originator (i.e. the screen saver management application 405 as described herein and illustrated in FIG. 9) or any other identification tag. In Step 244, when no identification tag is required in Step 243, the new message is processed. The processing of the new message, for example, can include modifying the message text, displaying the message within the two way messaging interface window 240 of the display 225, marking the new message as “read”, and/or storing the new message in the electronic memory. Modifying the message text can include for example, filtering the text based on the service provider. Filtering can include removing portions of the original message not pertinent to the communication. In Step 246, when an identification tag is required in Step 243, the screen saver messaging application 230 determines whether an identification tag has been received. When an identification tag has been received, the process continues with Step 244 and the message including the identification tag is processed. The processing including the identification tag, for example, can include displaying the message within a particular two way messaging interface window corresponding to the message session and/or message originator identified by the identification tag. The processing further can include storing the message in the inbox 137 of the mass storage element 135. Next in Step 247, after processing the new message in Step 244, and/or when no new message is received from the information processing device user in Step 242, and/or when no identification tag has been received for the new message in Step 246, the screen saver messaging application 230 determines whether it is time to check for new messages. When it is time to check for new messages, the process cycles back to Step 242 and periodically checks for new messages received from the information processing device user. When it is not time to check for new messages in Step 247, the screen saver messaging application 230 determines, in Step 248, whether the message session is completed and/or there has been a predetermined period of inactivity. When the messaging session is not completed nor has a period of inactivity been experienced, the process cycles back to Step 247 and periodically checks whether it is time to check for new messages. In Step 249, when the message session is completed and/or there has been a predetermined period of inactivity, the messages included within the messaging session are stored in the electronic memory. When the messages sent from electronic information processing device 110 were acknowledged by the communication device 60, then the message session preferably is stored in the screen saver folder 136 within the mass storage element 135. When the messages sent from the electronic information processing device 110 are not acknowledged by the communication device 60 then the unacknowledged sent messages are preferably stored in an unread message folder such as the inbox 137 of the mass storage element 135. The process then ends.

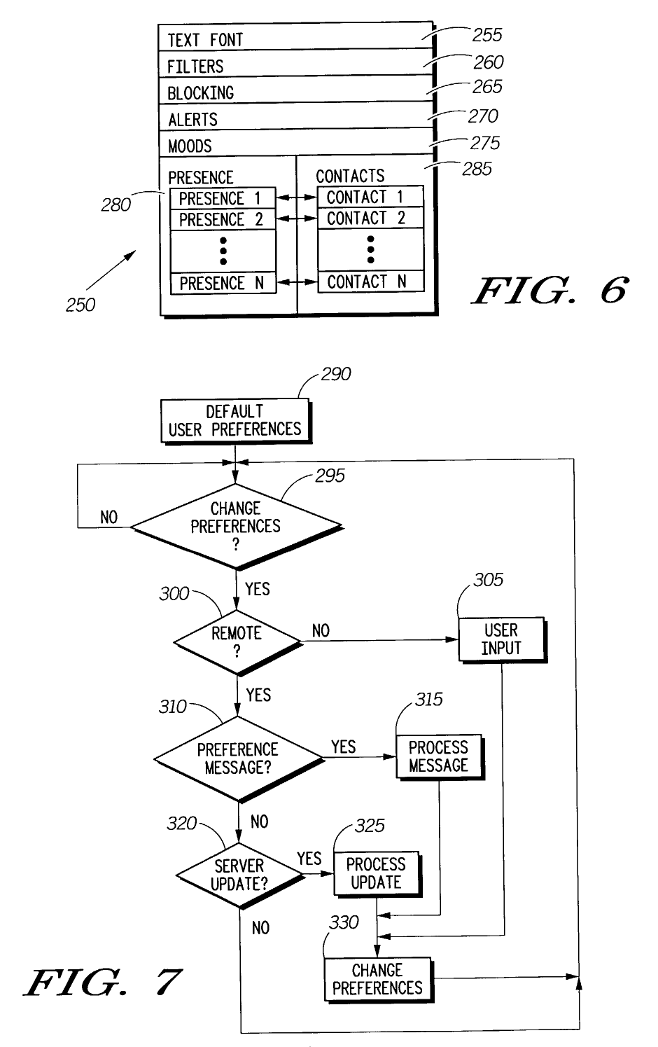

FIG. 6 illustrates a plurality of user preferences 250 that can be utilized by the screen saver messaging application 230. The plurality of user preferences 250 defines certain attributes settable by the information processing device user for communicating within one or more messaging sessions. The plurality of user preferences 250, for example, can include text font attributes 255, filter settings 260, blocking settings 265, alert settings 270, mood settings 275, presence settings 280, (available at work, available at home or not available) and associated methods of contact 285. It will be appreciated by one of ordinary skill in the art that the plurality of user preferences, in accordance with the present invention, can include any of those preferences mentioned herein or an equivalent.

The presence settings 280 can affect the operation and characteristic of the screen saver messaging application 230. For example, the method of communication message 235, the second window of scrolling text 239, and/or photos used in a slide show can change based on the information processing device user's location, photos used in a slide show can further change based on the presence settings 280. Similarly, the graphical depiction in which the two way messaging interface window 240 resides within the display 225 can be changed based on location or device used by the information processing device user. For example, when the information processing device user is at home the graphical depiction can be a personal computer and when the information processing device user is traveling the graphical depiction can be a wireless communication device.

In accordance with the present invention, an information processing device user can update user preferences currently being used by the screen saver messaging application 230. FIG. 7 is an exemplary flow diagram illustrating one embodiment of the operation of updating the user preferences currently in use in accordance with the present invention. In Step 290, the user preferences are set to their defaults. Next, in Step 295, the process determines whether the information processing device user desires/requires to change preferences of the active user. When the information processing device user does not desire/require a change to the preferences, the process cycles back to Step 295 and continues to utilize the current preferences while periodically checking whether a change of preferences is required/desired. In Step 300, when the information processing device user does desire/require to change the preferences in Step 295, the process determines whether the information processing device user is remotely located from the electronic information processing device 110. In Step 305, when the information processing device user is not remotely located in Step 300, the information processing device user provides a user input via the user interface 155 including the desired changes to the user preferences. It will be appreciated by one of ordinary skill in the art that the user input can further and/or alternatively include changes to the stored plurality of user preferences 250. For example, the information processing device user can update a method of contact associated with one or more of the presence settings 280. In Step 310, when the information processing device user is remotely located from the electronic information processing device 110, the process determines whether the information processing device user has sent a preference message to the electronic information processing device 110. For example, the information processing device user, via the communication device 60 can send a preference message including one or more changes to the user preferences of the within the uplink message 85 via the two way messaging system 10. The preference message can further include an update to the method of communication message 235 and or the second window of scrolling text 239. In accordance with the present invention, alternatively, the device user can authorize the capability to proxy or have someone else to update the active and/or stored user preferences remotely. The electronic information processing device 110 can receive the uplink message 85 through the two way messaging system 10 as previously described for FIG. 2. In Step 315, when the information processing device user has sent a preference message, the message is processed by the electronic information processing device 110 as described previously for FIG. 2. In Step 320, when no preference message has been communicated in Step 310, the process determines whether one or more messaging servers (i.e. the messaging server 335 of FIG. 1) has relayed a user preference update to the electronic information processing device 110. When no server update has been communicated, the process cycles back to Step 295 and periodically checks whether the information processing device user desires/requires to change the user preferences. In Step 325, when an update has been received from a messaging server, the electronic information processing device 110 processes the update as described previously for processing messages in FIG. 2. Next, and after the completion of Steps 305 and/or 315 and/or 325, in Step 330 the user preferences are changed using the information received and processed.

In accordance with one embodiment of the present invention, the screen saver messaging application 230 is programmed to adapt it's functionality in response to detecting the local presence of a person and further identifying the person. (either the information processing device user or a visitor). For example, the message displayed on the screen in the first mode and/or the message displayed on the screen in the second mode may include a personal message for the specific visitor. Also, the first screen layout can change to a layout for the specific visitor. Also, outgoing messages can be identified as being from that specific visitor. Another example is when the person is the information processing device user, in which case the standard screen saver operation is used.

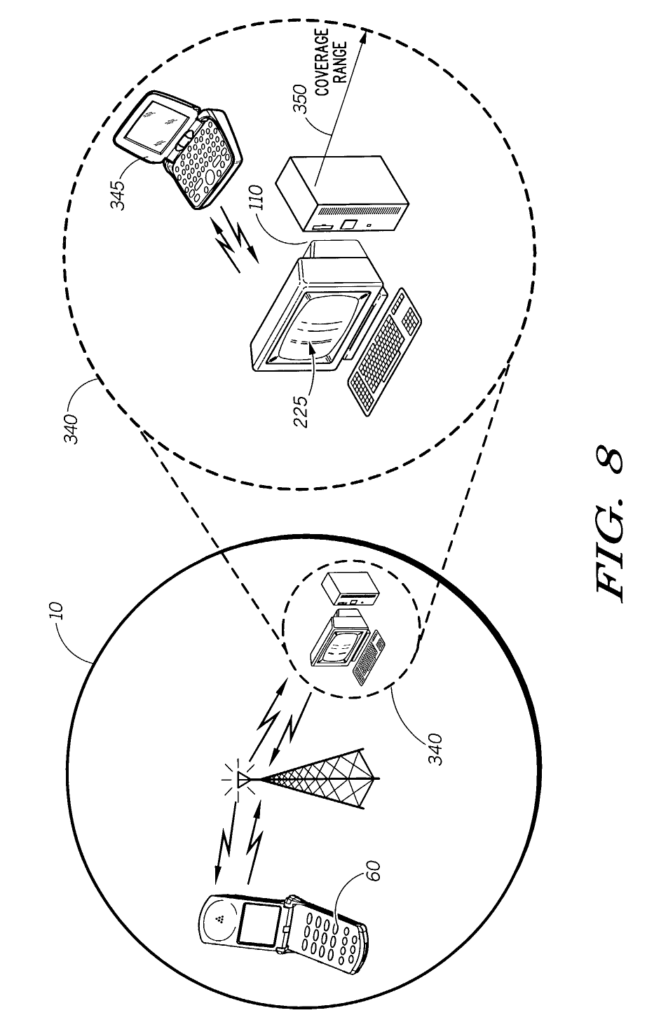

As illustrated in FIG. 8, the electronic information processing device 110 preferably operates within a short-range protocol system 340. It will be appreciated by one of ordinary skill in the art that the short range protocol system 340, in accordance with the present invention, can function utilizing any short range wireless protocol such as Bluetooth, IrDA, HomeRF, and IEEE 802.11. These short range WLAN protocols operate at lower power and over shorter distances. These short range WLAN protocols generally use unlicensed spectrum and require minimal coordination with the secondary communication protocol of the device (e.g., GSM, IS-95, IS-136, ReFLEX™, etc.).

Short range wireless communication can be, for example, provided using an Infrared Data Association (IrDA) communication standard. IRDA is a point-to-point, narrow angle (30 degree cone), ad-hoc data transmission standard designed to operate over a distance of zero (0) to one (1) meter and at speeds of 9600 bits per second to 16 Mega bits per second. Similarly, the short-range communication can be provided using a Bluetooth communication standard. Bluetooth is a short range, point-tomultipoint voice and data transfer standard designed to operate over a nominal distance of ten (10) centimeters to ten (10) meters, but can be extended to one hundred (100) meters by increasing transmit power. Bluetooth operates in the 2.4 Gigahertz radio frequency range.

Preferably, each visitor entering a coverage range 350 can be identified by the electronic information processing device 110 using a short range communication device 345 unique to that individual. When the electronic information processing device 110 detects the short range communication device 345, it communicates with the short range communication device 345 to receive information regarding the individual visitor using the short range communication device 345. The electronic information processing device 110, in accordance with the present invention, can grant or deny access to the two way messaging interface window 240 by comparing the person whose presence has been detected to a preprogrammed list of authorized message communicators. In other words, the screen saver messaging application 230 can utilize short range wireless presence to restrict certain individual visitors or groups from utilizing the two way messaging interface window 240 to communicate with the information processing device user. For example, Bluetooth's user-friendly name can be used to restrict access. The method of communication message 235 can be updated to notify the individual that they do not have access authority. Further, the presence of visitors proximately located near the electronic information processing device 110 can be transmitted to the information processing device user's communication device 60 using the two way messaging system 10.

Further, when the electronic information processing device 110 does not know the visitor, a message can be sent to the information processing device user's communication device 60 with the visitor's information requesting access approval. For example, pictures/images of the visitor can be transmitted utilizing camera hardware (not shown) coupled to the screen saver messaging application 230. Alternatively, a service discovery mechanism, utilizing Bluetooth, radio frequency identification (RFID) or other forms of personal identification, such as facial recognition, can be used to identify automatically the visitor requesting a message session. (i.e. person typing in message.)

In one embodiment, once the visitor is identified, the information processing device user can allow selective access to the electronic memory of the electronic information processing device 110. The information processing device user can, for example, send a memory access message from the communication device 60 to the electronic information processing device 110 allowing the visitor selective access to information stored in the electronic memory.

FIG. 9 is an electronic block diagram of a communication device 60 for use within the two way messaging system of FIG. 1, in accordance with a preferred embodiment of the present invention. It will be appreciated by one of ordinary skill in the art that the electronic block diagram of FIG. 2 is illustrative of each of the plurality of communication devices 75 assigned for use in the two way messaging system 10.

Referring to FIG. 9, the communication device 60 includes a first device antenna 355, a second device antenna 360, a device receiver 365, a device transmitter 370, a device clock 375, a device processor 380, a device memory 385, an alert circuit 390, a device display 395, a device user interface 400, and a screen saver management application 405. It will be appreciated by one of ordinary skill in the art that the screen saver management application 405 can be a software program or any other equivalent.

The first device antenna 355 intercepts transmitted signals from the two way messaging system 10. The first device antenna 355 is coupled to the device receiver 365, which employs conventional demodulation techniques for receiving the communication signals transmitted by the two way messaging system 10 such as the downlink message 65 of FIG. 1.

Coupled to the device receiver 365, is the device processor 380 utilizing conventional signal-processing techniques for processing received messages. Preferably, the device processor 380 is similar to the MC68328 micro-controller manufactured by Motorola, Inc. of Schaumburg, Ill. It will be appreciated by one of ordinary skill in the art that other similar processors can be utilized for the device processor 380, and that additional processors of the same or alternative type can be utilized as required to handle the processing requirements of the device processor 380.

The device processor 380 decodes an address in the demodulated data of the received message, compares the decoded address with one or more addresses such as the address 100 stored in an address memory 410 of the device memory 385; and when a match is detected, proceeds to process the remaining portion of the received message.

To perform the necessary functions of the communication device 60, the device processor 380 is coupled to the device memory 385, which preferably includes a random access memory (RAM), a read-only memory (ROM), and an electrically erasable programmable read-only memory (EEPROM)(not shown). The device memory 385 is comprised of the address memory 410, a message memory 415, and a screen saver message memory 420.

FIG. 10 illustrates further detail of the screen saver message memory 420 in accordance with a preferred embodiment of the present invention. As illustrated, the screen saver message memory 420 preferably stores one or more screen saver user preferences 425. The one or more screen saver user preferences 425 can include, for example, attributes for alerting when screen saver messages are received 430, attributes for displaying when screen saver messages are received 435, a list of individuals and/or groups 440 authorized to send screen saver messages to the communication device 60, and the like. The screen saver message memory 420 preferably further stores one or more screen saver messages 445 associated with one or more screen saver messaging sessions 450 received by the communication device 60 preferably from the electronic information processing device 110.

Referring back to FIG. 9, once the device processor 380 has processed a received message, it determines whether the decoded message is a screen saver message 445. When the decoded message is not a screen saver message 445, it stores the decoded message in the message memory 415. It will be appreciated by one of ordinary skill in the art that the message memory 415, in accordance with the present invention, can be a group of memory locations in a data storage device or an equivalent. When the decoded message is a screen saver message 445, it stores the screen saver message 445 within the screen saver message memory 420 as previously described. The screen saver message 445, for example, can include an identification tag identifying it as a screen saver message for the device processor 380.

Upon receipt and processing of a message, the device processor 380 preferably generates a command signal to the alert circuit 390 as a notification that the message has been received and stored. The alert circuit 390 can include a speaker (not shown) with associated speaker drive circuitry capable of playing melodies and other audible alerts, a vibrator (not shown) with associated vibrator drive circuitry capable of producing a physical vibration, or one or more LEDs (not shown) with associated LED drive circuitry capable of producing a visual alert. It will be appreciated by one of ordinary skill in the art that other similar alerting means as well as any combination of the audible, vibratory, and visual alert outputs described can be used for the alert circuit 390. Preferably, and in accordance with the present invention, the command signal to the alert circuit 390 for notification of receipt and storage of a screen saver message differs from the command signal to the alert circuit 390 for notification of receipt and storage of a traditional message.

Upon receipt of a message, the device processor 380 preferably also generates a command signal to the device display 395 to generate a visual notification of the receipt and storage of the message. When the device display 395 receives the command signal from the device processor 380 that the message has been received and stored, a message indication is displayed. The message indication, for example can be the activation of one of a plurality of message icons on the device display 395. Preferably, and in accordance with the present invention, the message indication for a notification of receipt and storage of a screen saver message differs from the message indication for notification of receipt and storage of a traditional message. The device display 395 can be, for example, a liquid crystal display, a dot matrix display, or an equivalent.

In order to display a message, the device processor 380 generates a command signal to the device display 395 to generate a visual presentation of the message. Preferably, and in accordance with the present invention, the visual presentation of a screen saver message differs from the visual presentation of a traditional message. For example, the visual presentation of a screen saver message may include the text of the message within a scrollable text box and a text input box for entering a reply whereas the visual presentation of a traditional message may include the text of the message within a pop-up window.

In a preferred embodiment, the communication device 60 includes the screen saver management application 405. The screen saver management application 405 is programmed to process one or more screen saver messages 445 received by the device receiver 365 and/or stored in the screen saver message memory 420, and to identify personalized screen saver messages to be displayed to the communication device user on the device display 395. The screen saver management application 405 can be hard coded or programmed into the communication device 60 during manufacturing, can be programmed over-the-air upon customer subscription, or can be a downloadable application. It will be appreciated by one of ordinary skill in the art that other programming methods can be utilized for programming the screen saver management application 405 into the communication device 60.

The screen saver management application 405, in response to a processor command, preferably accesses the screen saver message memory 420 of the device memory 385. The screen saver management application 405 is programmed with a set of rules identifying the management of the one or more screen saver messages 445 received by the device receiver 365 and/or stored in the screen saver message memory 420. For example, the screen saver management application 405 can be programmed to filter screen saver messages based on the service provider. (i.e. remove portions of the original message not pertinent to the communication) The screen saver management application 405 can further be programmed to identify the originator of each screen saver message based on a sender ID (identification) and replace the screen saver identification with the identification of the screen saver message guest. Bluetooth's user friendly address is an example of a sender ID that could be used to replace the screen saver ID. Further, the screen saver management application 405 can be programmed to include the response channel for one or more messaging provider's addresses. For example, the screen saver management application 405 can identify that the communication device 60 should send reply messages from one email address to a different, associated reply email address. The screen saver management application 405 can also identify the one or more screen saver messages 445 to be displayed on the device display 395 including any associated message attributes. The device processor 380, in response to receipt of an application response sends a command signal to the device display 395 including the information identified by the screen saver management application 405.

Preferably, the device user interface 400 is coupled to the device processor 380, as shown in FIG. 9. The device user interface 400 can be one or more buttons used to generate a button press, a series of button presses, a voice response from the communication device user, or some other similar method of manual response initiated by the communication device user of the communication device 60. The device processor 380, in response to the device user interface 400, initiates a processor command to the screen saver management application 405 when the user input indicates a requested screen saver management application 405 function from the communication device user. The screen saver management application 405, in response to the processor command can alter the displayed screen saver messages 445 and/or perform other actions on the one or more screen saver messages 445. For example, pressing a button on the device user interface 400 can cause all expired screen saver messages to be deleted and all newly received screen saver messages to be displayed.

The device processor 380, in response to the device user interface 400, can alternatively process a message entry when the user input indicates a requested message entry from the communication device user. For example, when the device user interface 400 includes a keypad, the communication device user can type a message to be sent using the keypad. In response to the received user input, the device processor 380 sends a command to the transmitter 370. In one embodiment, the device processor 380 can include an identification tag identifying the message to be sent as including a screen saver message to be sent to the screen saver message application 230 residing on the electronic information processing device 110. The device transmitter 370 is coupled to the device processor 380 and is responsive to commands from the device processor 380. When the device transmitter 370 receives a command from the device processor 380, the device transmitter 370 sends a signal via the device second antenna 360 to the two way messaging system 10. The signal, for example, can be the uplink message 85. (see FIG. 1).

In an alternative embodiment (not shown), the communication device 60 includes one antenna performing the functionality of the first device antenna 355 and the second device antenna 360. Further, the communication device 60 alternatively includes a transceiver circuit performing the functionality of the device receiver 365 and the device transmitter 370. It will be appreciated by one of ordinary skill in the art that other similar electronic block diagrams of the same or alternate type can be utilized for the communication device 60 to handle the requirements of the communication device 60.

The present invention as described herein provides a display screen saver with two way messaging capability and method. Although the invention has been described in terms of preferred embodiments, it will be obvious to those skilled in the art that various alterations and modifications can be made without departing from the invention. Accordingly, it is intended that all such alterations and modifications be considered as within the spirit and scope of the invention as defined by the appended claims.

What is claimed is:

1. An electronic information processing device comprising:
a transceiver for receiving one or more messages from at least one communication device and for transmitting one or more messages to the at least one communication device;
a CPU coupled to the transceiver for processing the received and transmitted messages;
a display coupled to the CPU comprising:
a first screen layout including a screen saver graphic, and
a second screen layout including a two way messaging interface window for displaying the received and transmitted messages,
wherein the CPU activates the second screen layout for two way messaging communication with at least one information processing device user.

2. An electronic information processing device as recited in claim 1 wherein the first screen layout includes a method of communication message including instructions for communicating with the at least one information processing device user.

3. An electronic information processing device as recited in claim 2 wherein the method of communication message comprises messages selected from the group consisting of a plurality of scrolling text, a plurality of audio messages, and a plurality of graphical messages.

4. An electronic information processing device as recited in claim 2 wherein the method of communication message changes in response to the transceiver receiving a message include a plurality of information from the at least one information processing device user.

5. An electronic information processing device as recited in claim 4 wherein the plurality of information comprises information selected from the group consisting of a location of the information processing device user and a preference message.

6. An electronic information processing device as recited in claim 1 wherein the second screen layout includes a second window of scrolling text including additional information for communicating with the information processing device user.

7. An electronic information processing device as recited in claim 6 wherein the second window of scrolling text changes in response to the transceiver receiving a message including a plurality of information from the information processing device user.

8. An electronic information processing device as recited in claim 7 wherein the plurality of information comprises information selected from the group consisting of a location of the information processing device user and a preference message.

9. An electronic information processing device as recited in claim 1 wherein the first screen layout changes in response to the transceiver receiving a messaging including a plurality of information from the information processing device user.

10. An electronic information processing device as recited in claim 9 wherein the plurality of information from the information processing device user comprises information selected from the group consisting of a location of the information processing device user and a preference message.

11. An electronic information processing device as recited in claim 1 wherein the second screen layout changes in response to the transceiver receiving a messaging including a plurality of information from the information processing device user.

12. An electronic information processing device as recited in claim 11 wherein the plurality of information from the information processing device user comprises information selected from the group consisting of a location of the information processing device user and a preference message.

13. An electronic information processing device as recited in claim 11 wherein the second screen layout changes from a standard screen saver layout to a messaging screen saver layout.

14. An electronic information processing device as recited in claim 11 wherein the second screen layout changes from a messaging screen saver layout to a standard screen saver layout.

15. An electronic information processing device as recited in claim 1 wherein the electronic information processing device further comprises a user interface responsive to a user input, and further wherein the CPU activates the second screen layout in response to the user interface receiving the user input.

16. An electronic information processing device as recited in claim 1 further comprising:
a screen saver messaging application coupled to the CPU for managing a plurality of screen saving two way messaging functions by providing one or more commands to the CPU,
wherein the CPU activates the second screen layout in response to the command from the screen saver messaging application.

17. An electronic information processing device as recited in claim 1 wherein the two way messaging interface window includes a status indicator of messaging activity.

18. An electronic information processing device as recited in claim 1 wherein the two way messaging interface window includes an appearance scheme, and further wherein the appearance scheme is associated with a location of the information processing device user.

19. An electronic information processing device as recited in claim 1 wherein the two way messaging interface window includes an appearance scheme, and further wherein the appearance scheme is associated with the communication device of the information processing device user.

20. An electronic information processing device as recited in claim 1 further comprising an electronic memory coupled to the CPU, wherein the electronic memory comprises:
an inbox for storing the one or more messages, and
a screen saver folder for storing the one or more messages in response to receipt of an acknowledgement message from the communication device.

21. An electronic information processing device as recited in claim 1 further comprising an electronic memory coupled to the CPU, wherein the two way messaging communication comprises one or more messaging sessions including one or more screen saver messages, and further wherein the electronic memory comprises:
an inbox for storing the one or more messages, and
a screen saver folder for storing a messaging session of the one or more messaging sessions in response to receipt of an acknowledgement of a screen saver message associated with the messaging session.

22. An electronic information processing device as recited in claim 1 wherein the two way messaging interface window displays one or more messaging sessions including one or more screen saver messages, wherein each of the one or more screen saver messages includes an identification tag identifying the message as the screen saver message.

23. An electronic processing device as recited in claim 22 wherein the two way messaging interface window further displays a session history of the screen saver messages received and transmitted for each of the messaging sessions in the form of a scrolling dialog.

24. An electronic information processing device as recited in claim 1 wherein at least one of the one or more messages transmitted to the at least one communication device includes an identification tag identifying the message as a screen saver message from the two way messaging interface window.

25. A method for two way messaging communication using a display screen saver within an electronic information processing device comprising:
activating a first screen layout of the display screen saver;
displaying a method of communication message within the first screen layout;
activating a second screen layout of the display screen saver in response to a user input; and
displaying a two way messaging interface window within the second screen layout, wherein the two way messaging interface window displays one or more screen saver messages communicated with a communication device.

26. A method for two way messaging communication using a display screen saver within an electronic information processing device as recited in claim 25, the method further comprising:
displaying a second window of scrolling text within the second screen layout including additional information for communicating with the information processing device user.

27 A method for two way messaging communication using a display screen saver within an electronic information processing device as recited in claim 25, the method further comprising:
receiving a message;
determining if the message is a screen saver message; and
further processing the message if it determined to be a screen saver message.

28. A method for two way messaging communication using a display screen saver within an electronic information processing device as recited in claim 27, wherein the determining if the message is for the screen saver step comprises:
determining if the message is from an information processing device user.

29. A method for two way messaging communication using a display screen saver within an electronic information processing device as recited in claim 28, wherein the determining if the message is from an information processing device user comprises:
determining if the message sender's email address is equivalent to the email address of the information processing device users communication device.

30. A method for two way messaging communication using a display screen saver within an electronic information processing device as recited in claim 29, wherein the determining if the message senders email address is equivalent to the email address of the information device process user step comprises:
utilizing a preprogrammed list of equivalent email domains for different communication device service providers.

31. A method for two way messaging communication using a display screen saver within an electronic information processing device as recited in claim 27, wherein the determining if the message is a screen saver message step comprises:
determining if the message contains an identification tag identifying the message as the screen saver message.

32 A method for two way messaging communication using a display screen saver within an electronic information processing device as recited in claim 27, wherein the further processing the message if it determined to be a screen saver message step comprises:
modifying the message based on the domain of the message sender's email address.

33. A method for two way messaging communication using a display screen saver within an electronic information processing device as recited in claim 25, wherein the activating of the first screen layout step comprises:
receiving an activation message from an information processing device user, and
activating the first screen layout of the display screen saver in response to receiving the activation message.

34. A method for two way messaging communication using a display screen saver within an electronic information processing device as recited in claim 25, the method further comprising:
clearing one or more existing messages from an input queue prior to the activating of the second screen layout step.

35. A method for two way messaging communication using a display screen saver within an electronic information processing device as recited in claim 25, the method further comprising:
receiving a preference message from the information processing device user; and
changing the method of communication message within the first screen layout in response to receiving the preference message.

36. A method for two way messaging communication using a display screen saver within an electronic information processing device as recited in claim 25, the method further comprising:
receiving a plurality of location information from the information processing device user; and
changing the method of communication message using the plurality of location information.

37 A method for two way messaging communication using a display screen saver within an electronic information processing device as recited in claim 25, the method further comprising:
receiving a plurality of location information from the information processing device user; and
changing an appearance scheme of the two way messaging interface window using the plurality of location information.

38. A method for two way messaging communication using a display screen saver within an electronic information processing device as recited in claim 25, the method further comprising:
storing the one or more screen saver messages in a first memory location;
receiving an acknowledgement message; and
storing the one or more screen saver messages in a second memory location in response to receiving the acknowledgement message.

39. A method for two way messaging communication using a display screen saver within an electronic information processing device comprising:
activating a first screen layout of the display screen saver;
identifying a person within a coverage range of the electronic information processing device;
customizing the display screen saver where the customization is associated with the identified person.

40. A method for two way messaging communication using a display screen saver within an electronic information processing device as recited in claim 39, wherein the customizing step includes changing between a standard screen saver layout and a messaging screen saver layout.

41. A method for two way messaging communication using a display screen saver within an electronic information processing device as recited in claim 39, wherein the customizing step includes activating a method of communication message on the first screen layout associated with the identified person.

42. A method for two way messaging communication using a display screen saver within an electronic information processing device as recited in claim 39, the method further comprising:
activating a second screen layout of the display screen saver including a two way messaging interface window and a second window of scrolling text; and.
wherein the customizing step includes customizing the second window of scrolling text based on the identified person.

43. A method for two way messaging communication using a display screen saver within an electronic information processing device as recited in claim 39, the method further comprising:
determining whether the identified person is an authorized message communicator; and
activating a second screen layout of the display screen saver including a two way messaging interface window when the identified person is an authorized message communicator.

44. A method for two way messaging communication using a display screen saver within an electronic information processing device as recited in claim 43 wherein the determining step comprises:
comparing the identified person to a list of authorized message communicators stored within a memory of the electronic information processing device.

45. A method for two way messaging communication using a display screen saver within an electronic information processing device as recited in claim 43 wherein the determining step comprises:
transmitting the identification of the person to a communication device of an information processing device user; and
receiving a message confirming the identified person is an authorized message communicator from the communication device.

46. A method for two way messaging communication using a display screen saver within an electronic information processing device as recited in claim 45 further comprising:
receiving a memory access message from the communication device; and
allowing the identified person selective access to information stored in an electronic memory of the electronic information processing device.
